(19) United States
(12) Patent Application Publication
(10) Pub. No.: US 2013/0104570 A1
(43) Pub. Date: May 2, 2013

(54) CRYOGENIC COOLING SYSTEM

(71) Applicant: Ernst Wolfgang Stautner, Niskayuna, NY (US)

(72) Inventor: Ernst Wolfgang Stautner, Niskayuna, NY (US)

(73) Assignee: GENERAL ELECTRIC COMPANY, SCHENECTADY, NY (US)

(21) Appl. No.: 13/285,929

(22) Filed: Oct. 31, 2011

(51) Int. Cl. F17C 5/00

(52) U.S. Cl. 62/45.1

(57) ABSTRACT

A cryogenic cooling system is presented herein. The system comprises an on-demand hydrogen reservoir adapted to be filled by an external hydrogen filling station. The system further comprises a cryocooler coupled with the on-demand hydrogen reservoir. The cryocooler is adapted to operate in a range from about 10 Kelvin to 20 Kelvin. The system further comprises a liquid hydrogen reservoir adapted to receive liquid hydrogen through the cryocooler. At least one superconducting magnet is adapted to operate in a range from about 10 Kelvin to 20 Kelvin and generate a magnetic field. Furthermore, the system comprises a plurality of cooling tubes adapted to receive liquid hydrogen from the liquid hydrogen reservoir, wherein the cooling tubes are adapted to cool down the superconducting magnet.

### BACKGROUND

The subject matter disclosed herein relates to a magnetic resonance imaging (MRI) system and in particular relates to a cryogenic cooling system in the MRI system.

Magnetic resonance imaging (MRI) is a medical imaging technique used in radiology to visualize detailed internal structures of a patient. MRI systems utilize a superconducting magnet to generate a strong and uniform magnetic field within which the patient is placed. The superconducting magnet consists of individual superconducting magnet coils that are placed within a cryogenic liquid to maintain their superconductivity. An MRI system comprises a cryocooler which provides cooling to balance the heat load of the superconducting magnet so that no cryogen is lost. The cryocooler comprises a combination of a regenerator and a displacer, to cool down the gaseous cryogen into a liquid form.

Conventionally, the liquid cryogen used in MRI systems is liquid helium. Due to rapidly increasing demand for liquid helium and its limited availability, the cost of this cryogenic liquid has been increasing steadily. Additionally, liquid helium boils at a very low temperature. In order to maintain the temperature below the boiling point of liquid helium, expensive 4 Kelvin (K) cryocoolers are used. The 4K cryocoolers use rare earth element based alloys (also called regenerator material) such as Holmium (HoCu₂), Erbium (Er₃Ni), and alloys of Gadolinium, Neodymium etc. The regenerator material for the 4K cryocoolers as well as the production process of this regenerator material is very expensive and thus, makes the cost of the 4K cryocooler expensive.

### SUMMARY

The above and other drawbacks/deficiencies may be overcome or alleviated by embodiment of a system for cryogenic cooling in a Magnetic Resonance Imaging (MRI) system. The system comprises an on-demand hydrogen reservoir adapted to be filled by an external hydrogen filling station. The system further comprises a cryocooler coupled with the on-demand hydrogen reservoir. The cryocooler is adapted to operate in a range from about 10 Kelvin to 20 Kelvin. The system further comprises a liquid hydrogen reservoir adapted to receive liquid hydrogen through the cryocooler. At least one superconducting magnet is adapted to operate in a range from about 10 Kelvin to 20 Kelvin and generate a magnetic field. Furthermore, the system comprises a plurality of cooling tubes adapted to receive liquid hydrogen from the liquid hydrogen reservoir, wherein the cooling tubes are adapted to cool down the superconducting magnet.

An embodiment of the invention comprises a method for cryogenic cooling in a Magnetic Resonance Imaging (MRI) system. The method comprises filling an on demand hydrogen reservoir with gaseous hydrogen from an external hydrogen filling station. In one embodiment, the filling station supplies either gaseous, highly compressed gas or liquid hydrogen. Further, a cryocooler is operated in a range from about 10 Kelvin to 20 Kelvin. The cryocooler is selectively supplied with gaseous hydrogen from the on-demand hydrogen reservoir. Subsequently, the gaseous hydrogen is liquefied by liquefaction fins associated with the cryocooler. Further, the liquefied hydrogen is stored in a liquid hydrogen reservoir. At least one cooling tube is filled with liquid hydrogen from the liquid hydrogen reservoir. Further, at least one superconducting magnet is cooled through the cooling tube to an operating temperature in a range from about 10 Kelvin to 20 Kelvin.

### BRIEF DESCRIPTION OF THE DRAWINGS

FIG. 1 illustrates an exemplary Magnetic Resonance Imaging (MRI) system according to an embodiment of the present invention;

FIG. 2 illustrates a block diagram of an exemplary cryogenic cooling system according to an embodiment of the present invention;

FIG. 3 illustrates an exemplary system for selectively supplying gaseous hydrogen to a cryocooler for liquefaction, according to an embodiment of the present invention; and

FIG. 4 is a flowchart illustrating an example method of cooling in an MRI system, according to an embodiment of the present invention.

### DETAILED DESCRIPTION

Various embodiments will be described more fully hereinafter with reference to the accompanying drawings. Such embodiments should not be construed as limiting. For example, one or more aspects can be utilized in other embodiments and even other types of devices. In the drawings, like numbers refer to like elements.

In the following description, specific details are set forth such as specific quantities, sizes, etc. so as to provide a thorough understanding of embodiments. However, the embodiments presented herein may be practiced without such specific details also. In many cases, details concerning such considerations and the like have been omitted inasmuch as such details are not necessary to obtain a complete understanding of various embodiments and are within the skills of persons of ordinary skill in the relevant art.

Referring to the drawings in general, it will be understood that the illustrations are for the purpose of describing particular embodiments and are not intended to be limiting.

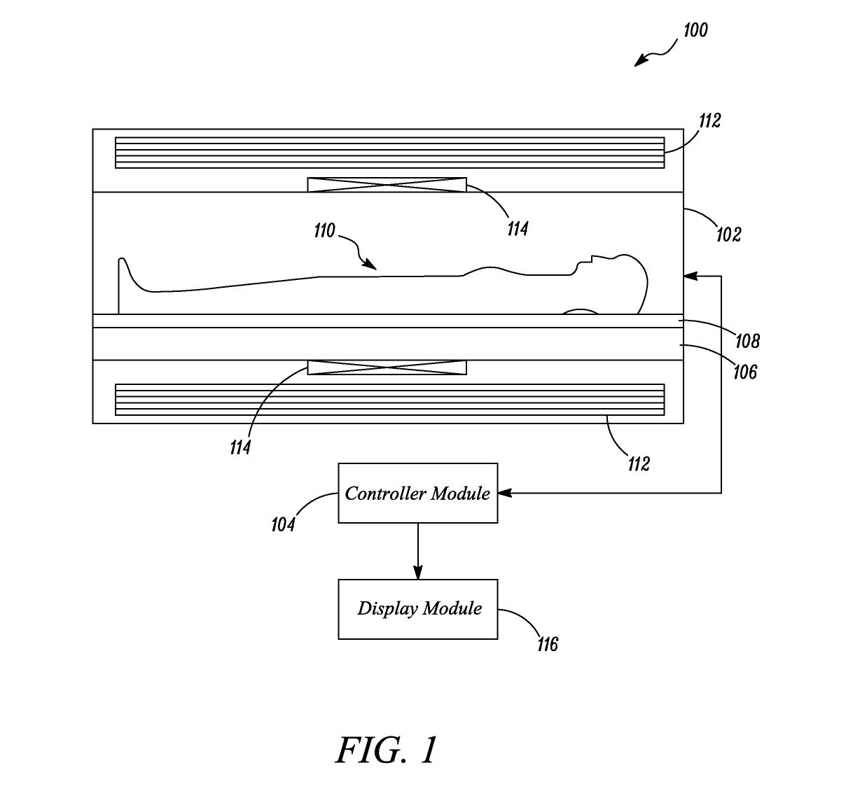

FIG. 1 illustrates an exemplary magnetic resonance imaging (MRI) system 100 in accordance with an embodiment of the present invention.

In an embodiment, the MRI system 100 may comprise a scanner 102 configured to scan a patient 110 placed on a table 108 within a patient bore 106 of the scanner 102. Examples of the scanner 102 may comprise, but not limited to, a full body scanner, a head scanner etc. In one embodiment, the scanner 102 is communicatively coupled to a controller module 104 for processing an MRI scan of the patient 110.

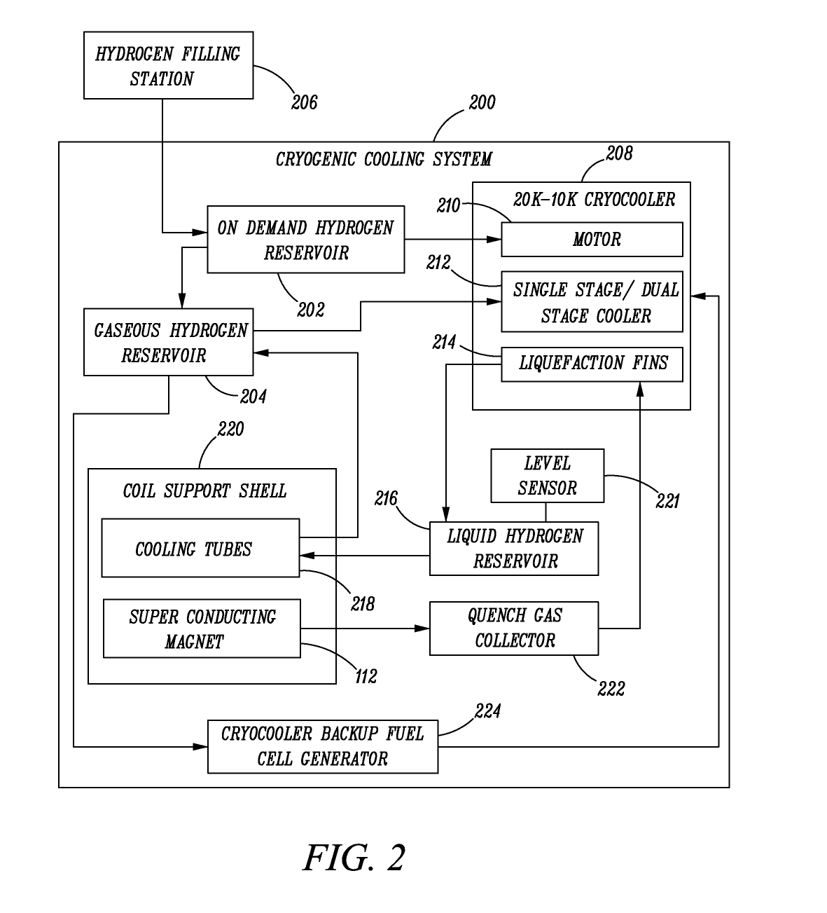

In one embodiment, the MRI system 100 may comprise a cryogenic cooling system 200, as illustrated in FIG. 2, configured to use liquid hydrogen as a cryogen, for operations. Liquid hydrogen is a desirable cryogen for use in MRI system 100 due to the abundance in its availability, heat transfer characteristics and thermal mass cool down property. Therefore, it is easy to compress, and expand hydrogen gas, cool down and liquefy the hydrogen gas at a lower temperature, i.e., 20 K. In one embodiment, the cryogenic cooling system 200 is configured to cool down superconducting magnet coils 112, hereinafter interchangeably referred to as the magnet 112, placed within a vacuum shell of scanner 102, and to provide heat balancing at the magnet 112. In one embodiment, the magnet 112 may comprise superconducting magnetic coils and is configured to generate strong magnetic fields that align with the magnetization of atoms in the body of the patient 110. A superconducting magnet consists of an arrangement of several individual superconducting magnet coils. A superconducting magnet, in its superconducting state possesses zero electrical resistance, and is capable of maintaining an intense magnetic field after completion of the field ramping process. In one embodiment, the cryogenic cooling system 200 may further comprise a cryocooler 208 configured to operate in a temperature range from 10 K to 20 K. In one embodiment, the cryocooler 208 operates to maintain a cryogenic temperature for the magnet 112, in order to maintain the superconductivity of the magnets 112.

Liquid hydrogen has a boil off temperature of 20 Kelvin (K). In one embodiment, liquid hydrogen used as the cryogen may enable the MRI system 100 to operate with medium temperature and low temperature type superconducting magnet 112. For example, the medium temperature superconducting magnet may operate at the temperature of liquid hydrogen, i.e., 20 K, however, the low temperature superconducting magnet may operate at a temperature below 18 K. The operating temperature of a superconducting magnet is the cryogenic temperature at which the superconducting magnet reaches its superconducting state. In one embodiment, the MRI system 100 operates with liquid hydrogen as a cryogen, at a sub-atmospheric pressure. The medium temperature superconducting magnet may perform at atmospheric as well as sub-atmospheric pressure, however, the low temperature superconducting magnet may perform only at sub-atmospheric pressure. Examples of the medium temperature superconducting magnet may comprise, but not limited to, magnesium diboride (MgB₂). In a further embodiment, the low temperature magnet may comprise, but not limited to, niobium-tin (Nb₃Sn), niobium-gallium (Nb₃Ga), and vanadium-gallium (V₃Ga).

There is a continuous heat load transferred to the magnet 112 from the coil support shell 220, for example, conduction and thermal radiation heat loads, that results in vaporization of the liquid hydrogen. As the liquid hydrogen has a boil off temperature of 20 K, therefore, hydrogen vaporizes at a temperature above 20 K. Therefore, in order to prevent the loss of the hydrogen, the cryocooler 208 re-cools and recondenses the evaporated hydrogen back into the liquid form, as the hydrogen liquefies at a temperature of 20 K. For this, the vaporized hydrogen is collected in a gas reservoir 204 which further selectively passes the gaseous hydrogen to the single stage/dual stage cooler 212. The cooler 212 further liquefies the gaseous hydrogen by using the liquefaction fins 214, for further reusing the liquid hydrogen in the system 200. Further, in an event of magnet quench, i.e., excessive heat loads where the superconducting magnet 112 lose their superconductivity, the vaporized hydrogen may also be collected in a quench gas collector 222 which selectively releases the hydrogen safely into atmosphere or outside the MRI room through a relief valve (not shown in the figure) in cases where the maximum operating pressure of the gas collectors is exceeded. In one embodiment, the cryocooler 208 as presented herein, produces a cooling power of 15 Watts required to cool down the magnets 112 to a temperature of 20 K.

Further, the scanner 102 may comprise a set of radio frequency (RF) coils 114. The RF coils 114 are configured to transmit radio frequency waves into the body of the patient 110. In principle, the radio frequency waves alter the alignment of the magnetization of the atoms in the body of the patient 110. As a result of this alteration, nuclei produce a rotating magnetic field that is detected by the scanner 102 to construct an image of the scanned area of the patient 110.

In one embodiment, the scanner 102 is coupled to the controller module 104 for processing information indicative of the magnetization of the atoms, the rotating magnetic field produced by the nuclei etc., to construct an image of the scanned area of the patient 110. The controller module 104 may further comprise a display module 116 configured to display the MRI image to a user of the MRI system 100. In one embodiment, the display module 116 may comprise interfaces to display devices such as a monitor, a printer, a mobile phone etc.

Although the description and the embodiments presented herein are with reference to the components of an MRI system, however, it will be understood by a person skilled in the art, that the description may be extended to a superconducting generator, wherein the components of the superconducting generator are implemented in a similar manner.

Referring now to FIG. 2, a block diagram of an exemplary cryogenic cooling system 200, hereinafter referred to as the cooling system 200, of the MRI system 100, is shown. In one embodiment, the cooling system 200 uses liquid hydrogen as a cryogen for cooling the superconducting magnet 112 and for providing heat balancing in cases of high heat loads at the magnet 112. In one embodiment, the MRI system 100 is a movable MRI system 100, which can be carried on a truck or any other similar vehicle, to an external hydrogen filling station 206 for refilling the MRI system 100 with liquid hydrogen. In an example, the external hydrogen filling station 206 is a known hydrogen filling station for the hydrogen automobile industry. In one embodiment, the external hydrogen filling station 206 is a compressed cold hydrogen (CcH2) filling station that delivers ultra-pure hydrogen such as 99.999% pure hydrogen, pressurized directly to fill the on-demand hydrogen reservoir 202 in the cooling system 200.

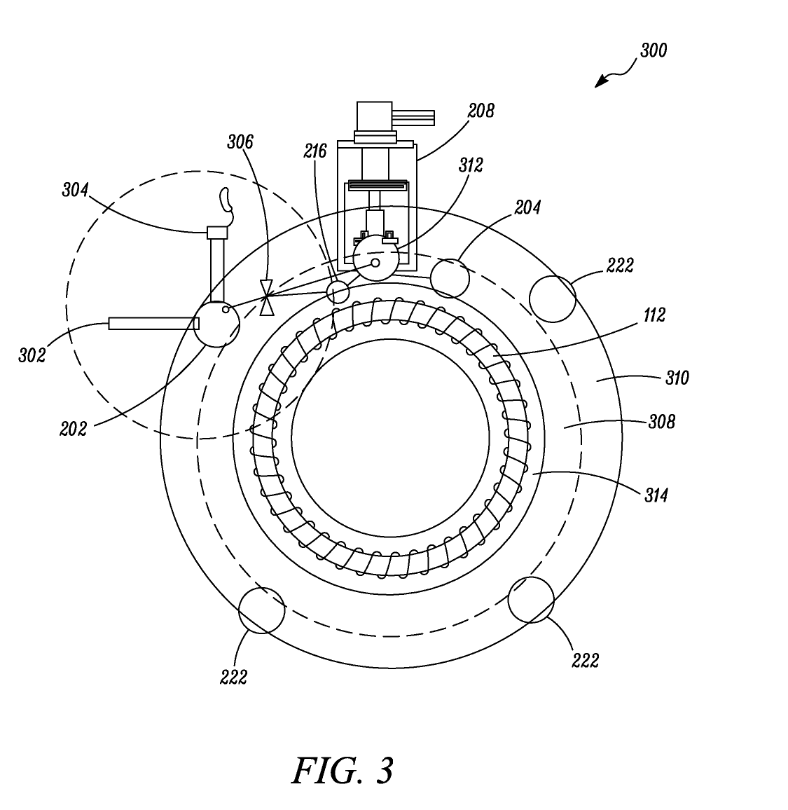

In one embodiment, the cooling system 200 may comprise an on-demand hydrogen reservoir 202 adapted to be filled with compressed hydrogen from the external hydrogen filling station 206. In a further embodiment, the external hydrogen filling station 206 fills pre-cooled hydrogen gas up to a temperature of 190 K or below, into the on-demand hydrogen reservoir 202. In one embodiment, a hydrogen fill port 302, as illustrated in FIG. 3, is configured to selectively fill the compressed hydrogen from the external hydrogen fill station 206 to the on-demand hydrogen reservoir 202. The on-demand hydrogen reservoir 202 has a fixed capacity. Once the on-demand hydrogen reservoir 202 is completely filled, then any additional amount of gas accidently filled, which is beyond the capacity of the on-demand hydrogen reservoir 202 is released into atmosphere through a safety valve 304.

In an embodiment, the on-demand hydrogen reservoir 202 is further configured to selectively supply gaseous hydrogen to the cryocooler 208, for liquefaction of the gaseous hydrogen. The on-demand hydrogen reservoir 202 selectively supplies the gaseous hydrogen to the cryocooler 208 through a control valve 306. In one embodiment, the control valve 306 is configured to remain closed while the on-demand hydrogen reservoir 202 is filled from the external hydrogen filling station 206. Further, the control valve 306 is adapted to open for supplying the gaseous hydrogen from the on-demand hydrogen reservoir 202 to the cryocooler 208 for liquefaction. In one embodiment, the fill port 302, the on-demand hydrogen reservoir 202, the safety valve 304 and the control valve 306 conform to the automobile standards for hydrogen vehicles.

Further, the cryocooler 208 is adapted to operate in a temperature range from 10 K to 20 K. The cryocooler 208 operates to maintain a cryogenic temperature for the magnets 112, so that the magnet 112 maintain their superconductivity. In one embodiment, the cryocooler 208 is configured to pre-cool the magnet 112 before starting operation of the MRI system 100. Further, the cryocooler 208 is configured to cool the magnet 112 during the operation of the MRI system 100 and re-cool the magnet 112 in the event of magnet quench during the operation of the MRI system 100. In one embodiment, the cryocooler 208 may provide a cooling power of 30 Watts at the operating temperature of 20 K.

In one embodiment, the cryocooler 208 may comprise a motor 210 configured to power and operate the cryocooler 208. Moreover, the cooling system 200 may further comprise a cryocooler backup fuel cell generator 224 configured to provide power backup to the motor 210 of the cryocooler 208 for ride through operations in an event of power failure. For example, the cryocooler backup fuel cell generator 224 provides gaseous hydrogen fuel to the motor 210 of the cryocooler 208 in an event of power failure for continuous operations. For this, the cooling system 200 may comprise the gaseous hydrogen reservoir 204 configured to be filled by the on-demand hydrogen reservoir 202. The gaseous hydrogen reservoir 204 is further configured to provide gaseous hydrogen to the cryocooler backup fuel cell generator 224.

Further, the cryocooler 208 may comprise a single stage/dual stage cooler 212, hereinafter referred to as the cooler 212 for cooling the selectively supplied gaseous hydrogen from the on-demand hydrogen reservoir 202. A dual stage cooler cools the gaseous hydrogen in two stages of compression and expansion. However, a single stage cooler uses a single stage compression and expansion to cool down the gaseous hydrogen. In one embodiment, the cooler 212 is a dual stage cooler for a full body MRI system 100. In an alternate embodiment, the cooler 212 is a single stage cooler for a small MRI system 100 such as a head scanner.

The cryocooler 208 may further comprise a plurality of liquefaction fins 214 configured to liquefy the cooled gaseous hydrogen from the cooler 212. In one embodiment, a liquefaction cup 312 is configured to hold the liquefaction fins 214. Further, the liquefaction fins 214 selectively fill a liquid hydrogen reservoir 216 of the cooling system 200. In one embodiment, the liquid hydrogen reservoir 216 is a 5 to 10 liter hydrogen reservoir conforming to the automobile standards. The liquid hydrogen reservoir 216 selectively receives the liquid hydrogen from the liquefaction fins 214 through a plurality of heat pipes (not shown in figures) that are chemically non-reactive with the hydrogen. In one embodiment, the liquid hydrogen reservoir 216 comprises a level sensor 221, configured to measure a fill level of the liquid hydrogen reservoir 216. In one embodiment, the level sensor 221 is based on the medium temperature superconductor magnet such as magnesium diboride (MgB₂).

In an embodiment of the present invention, the liquid hydrogen reservoir 216 is further configured to selectively fill cooling tubes 218 applied on a magnet former (not shown in the Figure) housing the magnet 112 within an inner vacuum shell 314. For example, the liquid hydrogen reservoir 216 selectively fills the cooling tubes 218 through the heat pipes by slowly opening a feed valve to the cooling tubes 218. As the cooling tubes 218 are completely filled, a thermosiphon action starts for cooling down the magnet 112. A thermosiphon action uses the difference of the density in the warm and cool portions of the liquid hydrogen within the cooling tubes 218, to maintain a circulatory flow within the cooling tubes 218 to continuously cool down the magnet 112.

In one embodiment, the magnet former housing the magnet 112 is coupled with cooling tubes 218 that are further enclosed in a coil support shell 220. In one embodiment, the coil support shell 220 may comprise, but not limited to, an outer vacuum shell 310, a thermal shield 308 and the inner vacuum shell 314, configured to absorb the heat loads from the coil support shell 220 and a gradient system superconducting magnet coil 112 interaction. In one embodiment, the thermal shield 308 is a solid thermal shield, and is of thickness range from 1 millimeter (mm) to 5 mm. In an alternate embodiment, a small MRI system 100 such as a head scanner that uses a single stage cooler 212, operates without the use of the thermal shield 308 using a plurality of soft shields only. In one embodiment, in case of rapture of the cooling tubes 218 and/or the thermal shield 308 due to very high heat loads, the hydrogen escapes into the vacuum space of the coil support shell 220. As there is no oxygen to react with the gaseous hydrogen in the vacuum space, the gaseous hydrogen acts as a self extinguishing gas that can be directly released into the atmosphere without causing any hazards to the users and the patients in the MRI room. In a further embodiment, the coil support shell 220 as presented herein results in a compact MRI system 100 and therefore increasing the size of the patient bore 106 for placing the patient 110 as shown in FIG. 1.

During operation, the liquid cryogen within the cooling tubes 218 attached to the individual magnet coil 112 is heated up to a temperature higher than the boil off temperature of the liquid hydrogen, i.e., 20 K, resulting in the evaporation of the liquid hydrogen. This is due to a transient magnet and a gradient interaction and the developed eddy current heating in the magnet coils of the magnet 112 and an internal cryostat structure of the MRI system 100 which is further transferred to the cooling tubes 218 filled with liquid hydrogen. The evaporated hydrogen needs to be immediately cooled down for liquefaction for reusing the liquid hydrogen in the cooling system 200. In one embodiment, the cooling system 200 as disclosed herein provides rapid cooling of the evaporated hydrogen For this, the vaporized hydrogen is stored in the gaseous hydrogen reservoir 204, which selectively passes the gaseous hydrogen to the single stage/dual stage cooler 212. Further, the cooler 212 liquefies the hydrogen using the liquefaction fins 214 of the cryocooler 208.

In the event of a magnet coil of the magnet 112 losing its superconducting property, known as magnet quench, the liquid hydrogen in the cooling tubes 218 may also evaporate. In one embodiment, the cooling system 200 may further comprise a quench gas collector 222 adapted to collect the vaporized hydrogen during an event of magnet quench. In one embodiment, the quench gas collector 222 is further adapted to selectively supply the gaseous hydrogen to the liquefaction fins 214 within the liquefaction cups 312 of the cryocooler 208 to recondense the gaseous hydrogen into the liquid form. In an alternate embodiment, the quench gas collector 222 is configured to selectively release a portion of quench gas into atmosphere external to the MRI system 100. In an alternate embodiment, the gaseous hydrogen reservoir 204 may provide the functionality of the quench gas collector 222. In one embodiment, the quench gas collector is placed axially in parallel to the axis of the superconducting magnet 112.

In one embodiment, the on-demand hydrogen reservoir 202, the liquid hydrogen reservoir 216, the gaseous hydrogen reservoir 204 and the quench gas collector 222 may comprise hydrogen sorption materials for providing safe storage of the gaseous hydrogen. Examples of the hydrogen reservoirs may comprise, but not limited to, carbon nanotubes or carbon nanostructures. The carbon nanotubes allow the hydrogen to bond with the carbon molecules resulting in a safe storage of hydrogen gas. Additionally, the pores of the carbon nanotubes absorb greater amount of hydrogen, resulting in higher storage capacity of hydrogen.

In one embodiment, the on-demand hydrogen reservoir 202, the liquid hydrogen reservoir 216, the gaseous hydrogen reservoir 204, the control valves, the heat pipes, the safety valve etc., conform to the automobile standards, and therefore are the components from the known automobile industry. Therefore, the various components used in the hydrogen driven MRI system 100 as presented herein, conform to the standards of safety and reliability.

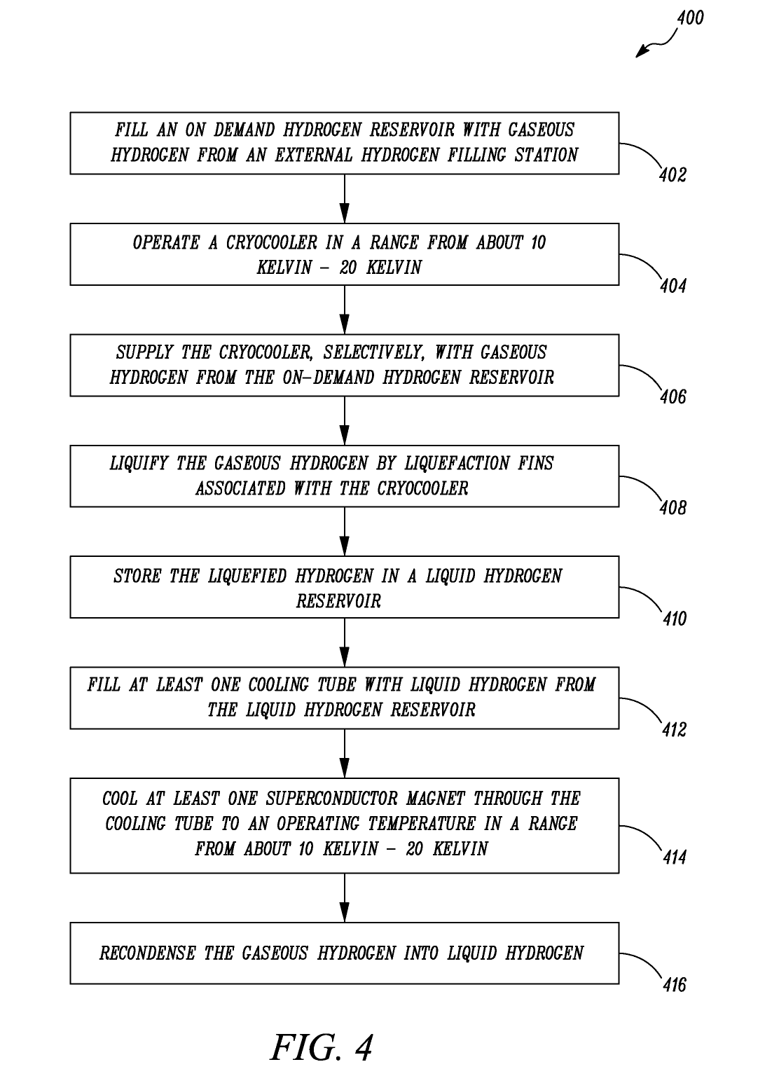

Referring now to FIG. 4, an exemplary flowchart is shown illustrating a method 400 of cryogenic cooling in an MRI system 100 according to an embodiment of the present invention. The method is performed for cooling down superconducting magnet coils placed within a vacuum shell in the MRI system 100, in order to maintain their superconductivity and balancing heat loads. In one embodiment, the MRI system 100 is a hydrogen based MRI system, i.e., the MRI system 100 uses liquid hydrogen as a cryogen for operations.

At step 402, an on-demand hydrogen reservoir is filled with gaseous hydrogen from an external hydrogen filling station. In one embodiment, a hydrogen fill port is configured to fill gaseous hydrogen into the on-demand hydrogen reservoir from the external hydrogen filling station. Once the on-demand hydrogen reservoir is completely filled, then any additional amount of gas accidently filled, which is beyond the capacity of the on-demand hydrogen reservoir is released into atmosphere. In one embodiment, the on-demand hydrogen reservoir and the safety valve conform to the automobile standards for hydrogen vehicles.

At step 404, a cryocooler is operated in a range from 10 K to 20 K. In one embodiment, the cryocooler is switched on to operate. The cryocooler operates to maintain a cryogenic temperature for the superconducting magnet, so that the magnet coils maintain their superconductivity. As explained previously, the cryocooler operates for a medium temperature superconducting magnet such as magnesium diboride (MgB₂) at a temperature of 20 K. In an alternate embodiment, the cryocooler operates for low temperature superconducting magnet such as niobium-tin (Nb₃Sn), niobium-gallium (Nb₃Ga), and vanadium-gallium (V₃Ga) at a temperature below 18 K. In one embodiment, the cooling system operates at a sub-atmospheric pressure for low temperature super conductor magnets. In a further embodiment, the cryocooler operates with a motor. In another embodiment, a gaseous hydrogen reservoir provides gaseous hydrogen to a cryocooler backup fuel cell generator. In one embodiment, the cryocooler backup fuel cell generator provides power backup to the cryocooler for ride through operations. For example, the cryocooler backup fuel cell generator provides gaseous hydrogen fuel to the motor of the cryocooler in an event of power failure for continuous operations.

At step 406, the cryocooler is selectively supplied with gaseous hydrogen from the on-demand hydrogen reservoir. In one embodiment, the on-demand hydrogen reservoir selectively supplies the gaseous hydrogen to the cryocooler through a control valve.

In one embodiment, the selectively supplied gaseous hydrogen is cooled by the cryocooler using single stage or dual stage cooling. In one embodiment, the cryocooler uses dual stage cooling for a full body MRI system. In an alternate embodiment, the cryocooler uses single stage cooling for a small MRI system such as a head scanner. Subsequently, at block 408, gaseous hydrogen is liquefied by at least one the liquefaction fins associated with the cryocooler.

Further, at block 410, the liquefied hydrogen is stored in a liquid hydrogen reservoir. The liquid hydrogen is selectively received by the liquid hydrogen reservoir, from the liquefaction fins through a plurality of heat pipes that are chemically non-reactive with the liquid hydrogen. In one embodiment, the liquid hydrogen reservoir is a 5 to 10 liter hydrogen reservoir conforming to the automobile standards. In one embodiment, the liquid hydrogen reservoir comprises a level sensor, configured to measure a fill level of the liquid hydrogen reservoir.

Subsequently, at step 412, at least one cooling tube is filled with liquid hydrogen from the liquid hydrogen reservoir. In one embodiment, the cooling tubes are selectively filled by the liquid hydrogen reservoir, through the heat pipes by slowly opening a feed valve to the cooling tubes. As the cooling tubes are completely filled, a thermosiphon action is started for cooling down the magnets. Generally, the thermosiphon action uses the difference of the density in the warm and cool portions of the liquid cryogen to maintain a circulatory flow within the cooling tubes to continuously cool down the superconducting magnet.

At step 414, at least one superconducting magnet is cooled through the cooling tubes to an operating temperature in a range from about 10 K to 20 K. In one embodiment, the superconducting magnet are covered with the cooling tubes that are further enclosed in a coil support shell. In one embodiment, the coil support shell comprises a thermal shield and a vacuum shell for absorbing the heat emitted from the magnets during operation.

At step 416, the gaseous hydrogen is recondensed into liquid hydrogen. In one embodiment, the gaseous hydrogen may be recondensed in an event of operation of the superconducting magnet or in an event of a magnet quench. In one embodiment, the magnets are heated up to a temperature higher than the boil off temperature of the liquid hydrogen, i.e., 20 K, resulting in the evaporation of the liquid hydrogen. The gaseous heated up hydrogen is immediately cooled down for liquefaction for reusing the liquid hydrogen in the cooling system. For this, the evaporated hydrogen is collected in a gaseous hydrogen reservoir which selectively passes the gaseous hydrogen to the cryocooler 208 for liquefaction by using liquefaction fins 214. In a further embodiment, the vaporized hydrogen in the event of magnet quench is collected in a quench gas collector. In one embodiment, the quench gases are selectively passed by the quench gas collector through the liquefaction fins of the cryocooler to recondense the gaseous hydrogen into the liquid form. In another embodiment, a fraction of quench gas is released into atmosphere external to the MRI system by the quench gas collector through a relief valve. In one embodiment, the quench gas collector is placed axially in parallel to the axis of the superconducting magnet.

While the invention has been described in considerable detail with reference to a few exemplary embodiments only, it will be appreciated that it is not intended to limit the invention to these embodiments only, since various modifications, omissions, additions and substitutions may be made to the disclosed embodiments without materially departing from the scope of the invention. In addition, many modifications may be made to adapt to a particular situation or an installation, without departing from the essential scope of the invention. Thus, it must be understood that the above invention has been described by way of illustration and not limitation. Accordingly, it is intended to cover all modifications, omissions, additions, substitutions or the like, which may be comprised within the scope and the spirit of the invention as defined by the claims.

1. A system comprising:
an on-demand hydrogen reservoir adapted to be filled by an external hydrogen filling station;
a cryocooler coupled with the on-demand hydrogen reservoir, wherein the cryocooler is adapted to operate in a range from about 10 Kelvin-20 Kelvin;
a liquid hydrogen reservoir adapted to receive liquid hydrogen through the cryocooler;
at least one superconducting magnet adapted to generate a magnetic field, wherein the superconducting magnet is adapted to operate in a range from about 10 Kelvin to 20 Kelvin; and
a plurality of cooling tubes adapted to receive liquid hydrogen from the liquid hydrogen reservoir, wherein the cooling tubes are adapted to cool down the superconducting magnet.

2. The system of claim 1, where in the system is utilized in at least one of a Magnetic Resonance Imaging (MRI) system or a superconducting generator.

3. The system of claim 2, where in the MRI system is adapted to operate at sub-atmospheric pressure.

4. The system of claim 1 further comprises at least one control valve adapted to selectively supply gaseous hydrogen to the cryocooler from the on-demand hydrogen reservoir.

5. The system of claim 1 further comprises a thermal shield adapted to absorb emitted heat from the superconducting magnet.

6. The system of claim 5, wherein the thermal shield thickness is in a range of about 1 to 5 millimeter (mm).

7. The system of claim 1, wherein the cryocooler further comprises liquefaction fins adapted to liquefy the gaseous hydrogen.

8. The system of claim 1, wherein the cryocooler is selected from a group comprising at least one of a single stage cryocooler and a dual stage cryocooler.

9. The system of claim 8, wherein the single stage cryocooler is adapted to operate without an application of a solid thermal shield in the system.

10. The system of claim 1 further comprises a cryocooler backup fuel cell generator adapted to provide power backup to the cryocooler for ride through operations.

11. The system of claim 10 further comprises a gaseous hydrogen reservoir adapted to provide hydrogen as a fuel to the cryocooler backup fuel cell generator.

12. The system of claim 1 further comprises a quench gas collector is placed axially in parallel with the axis of the at least one superconducting magnet.

13. The system of claim 12, wherein the quench gas collector is adapted to:
collect quench gases in an event of a magnet quench;
selectively supply at least a portion of the quench gas to the cryocooler for liquefaction; and
selectively release a portion of the quench gas external to the system.

14. The system of claim 1 further comprises at least one safety valve adapted to selectively release hydrogen from the on-demand hydrogen reservoir.

15. The system of claim 1 further comprises superconducting level indicator adapted to measure a fill level in the liquid hydrogen reservoir.

16. The system of claim 1, wherein the superconducting magnet is selected from a group comprising magnesium diboride (MgB2), niobium-tin (Nb3Sn), niobium-gallium (Nb3Ga), and vanadium-gallium (V3Ga).

17. The system of claim 1, wherein the on-demand hydrogen reservoir, the liquid hydrogen reservoir comprise hydrogen sorption materials.

18. The system of claim 1, wherein the on-demand hydrogen reservoir, the liquid hydrogen reservoir conform to automobile standards.

19. A method comprising:
filling an on demand hydrogen reservoir with gaseous hydrogen from an external hydrogen filling station;
operating a cryocooler in a range from about 10 Kelvin-20 Kelvin;
supplying the cryocooler, selectively, with gaseous hydrogen from the on-demand hydrogen reservoir;
liquefying the gaseous hydrogen by liquefaction fins associated with the cryocooler;
storing the liquefied hydrogen in a liquid hydrogen reservoir;
filling at least one cooling tube with liquid hydrogen from the liquid hydrogen reservoir; and
cooling at least one superconducting magnet through the cooling tube to an operating temperature in a range from about 10 Kelvin-20 Kelvin.

20. The method of claim 19 further comprising placing a quench gas collector placed axially in parallel with the axis of the at least one superconducting magnet.

21. The method of claim 20 further comprises collecting quench gases in the quench gas collector, in an event of quenching.

22. The method of claim 21 further comprising passing at least a portion of the quench gas through the liquefaction fins for re-condensing the quench gases.

23. The method of claim 19 further comprises providing power backup to the cryocooler by a backup fuel cell generator for ride through operations.

24. The method of claim 19 further comprises selectively releasing hydrogen from the on-demand hydrogen reservoir by at least one safety valve.

25. The method of claim 19, wherein the at least one superconducting magnet is selected from a group comprising magnesium diboride (MgB2), niobium-tin (Nb3Sn), niobium-gallium (Nb3Ga), and vanadium-gallium (V3Ga).

26. The method of claim 19 further comprises measuring, through a superconducting level indicator, a fill level of the liquid hydrogen reservoir.
